(19) United States
(12) Patent Application Publication
(10) Pub. No.: US 2015/0168545 A1
(43) Pub. Date: Jun. 18, 2015

(54) DISTANCE ESTIMATION DEVICE AND METHOD USING THE DIFFERENCE OF WAVE SPEED BETWEEN WAVES

(71) Applicants: Wan Ho CHO, Daejeon (KR); Hyu Sang KWON, Daejeon (KR); Young Won KIM, Daejeon (KR); Jin Eep ROH, Sejong-si (KR)

(72) Inventors: Wan Ho CHO, Daejeon (KR); Hyu Sang KWON, Daejeon (KR); Young Won KIM, Daejeon (KR); Jin Eep ROH, Sejong-si (KR)

(73) Assignee: AGENCY FOR DEFENSE DEVELOPMENT, Daejeon (KR)

(21) Appl. No.: 14/287,303

(22) Filed: May 27, 2014

(30) Foreign Application Priority Data
Dec. 13, 2013 (KR) 10-2013-0155779

(51) Int. Cl. G01S 11/14

(52) U.S. Cl. CPC G01S 11/14

(57) ABSTRACT

The present disclosure provides a distance estimation device, including a wave signal detection unit configured to measure different types of waves, respectively, to detect different wave signals, a time delay estimation unit configured to produce a correlation coefficient from the detected different wave signals, and computes an arrival time difference using the correlation coefficient, and a distance calculation unit configured to estimate the distance of a target object using an arrival time difference for each of the different types of waves.

### RELATED APPLICATION

Pursuant to 35 U.S.C. §119(a), this application claims the benefit of earlier filing date and right of priority to Korean Application No. 10-2013-0155779, filed on Dec. 13, 2013, the contents of which is incorporated by reference herein in its entirety.

### BACKGROUND OF THE INVENTION

1. Field of the Invention

The present disclosure relates to a distance estimation device for estimating the distance of a target generating sound waves and vibration and a distance estimation method using the same.

2. Description of the Related Art

A mobile interdiction bomb is a military weapon for detecting the approach and position of a target to approach an enemy tank (or armored vehicle), and attacking and destroying the most vulnerable portion of the tank when reaching the target.

On the other hand, dynamic waves such as sound or seismic waves have the characteristics of spatio-temporally travelling while periodically repeating expansion and contraction by the inertia and elasticity of a medium. Such waves are defined as sound waves in air, and shown as longitudinal waves since the volume is changed by compression with no shear force. However, transverse waves due to a shear force exist as a vector along with longitudinal waves in a solid medium. Waves for moving a medium in a direction perpendicular to the wave direction is referred to as transverse waves, and waves for expanding and contracting a medium in the wave direction is referred to as longitudinal waves.

Various types of waves in combination with longitudinal and transverse waves exist according to the boundary conditions of a medium, and they have each propagation characteristic. There are Rayleigh waves as representative surface waves shown along an infinite flat boundary surface such as a ground surface, and such waves characteristically have a unique wave propagation speed.

Accordingly, it will be proposed a device for estimating a distance up to a target object using waves generated from a target sound source intended to be detected by the mobile interdiction bomb, and a method thereof.

### SUMMARY OF THE INVENTION

An aspect of the present disclosure is to provide a device for employing a wave arrival time difference from a measurement signal to produce the distance of a target approaching from a far distance compared to the installation range of a sensor system for target detection in a mobile interdiction bomb, and a method thereof.

Furthermore, another aspect of the present disclosure is to provide a device for solving a lot of errors of distance estimations generated when using a sensor system having a relatively narrow distribution range compared to a distance from a sound source, and a method thereof.

In order to accomplish the foregoing objectives, a distance estimation device according to an embodiment of the present disclosure may include a wave signal detection unit configured to measure different types of waves, respectively, to detect different wave signals, a time delay estimation unit configured to produce a correlation coefficient from the detected different wave signals, and computes an arrival time difference using the correlation coefficient, and a distance calculation unit configured to estimate the distance of a target object using an arrival time difference for each of the different types of waves.

According to an example associated with the present disclosure, the wave signal detection unit may include a plurality of wave signal detectors formed to measure and detect the different types of waves, respectively, and a signal stabilization unit having a plurality of signal conditioners connected to the wave signal detectors, respectively, to stabilize each of the wave signals.

According to another example associated with the present disclosure, the distance estimation device may include a signal processing unit configured to remove the noise of the detected wave signals and filter out signals in a specific frequency band transferring the same component signal. The signal processing unit may include an analog signal processing unit configured to remove a noise signal and filter out signals in a specific frequency band for each of the wave signals transferred from the wave signal detection unit, and a digital signal conversion unit configured to convert wave signals processed by the analog signal processing unit into a digital signal.

According to another example associated with the present disclosure, the time delay estimation unit may include a signal correlation estimation unit configured to compute and produce a correlation between the detected different wave signals, and an arrival time difference computation unit configured to compute an arrival time difference for each of the different types of waves from the produced correlations. The signal correlation estimation unit may compute correlations between signals through the computation of at least one of a time domain and a frequency domain using signal waveform data stored therein. The signal correlation estimation unit may use interpolation and zero padding between data as a method of accurately estimating the location of a peak value from a correlation function between signals, and determine an estimation error for estimating an arrival time difference according to the sampling frequency.

According to another example associated with the present disclosure, the distance calculation unit may estimate a distance from an arrival time difference using a unique wave propagation speed for each wave used for distance estimation.

Furthermore, the present disclosure discloses a distance estimation method including measuring different types of waves, respectively, to detect different wave signals, producing a correlation coefficient from the detected different wave signals, and computing an arrival time difference using the correlation coefficient, and estimating the distance of a target object using an arrival time difference for each of the different types of waves.

According to a distance estimation device and a distance estimation method having the foregoing configuration, it may be possible to estimate a distance using an arrival time difference between waves being propagated from a target object.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a configuration diagram illustrating the configuration of a distance estimation device according to an embodiment of the present disclosure;

FIG. 2 is a conceptual view illustrating the basic principle of a distance estimation device and a distance estimation method according to the present disclosure; and

FIG. 3 is a flow chart illustrating a distance estimation method applicable to a distance estimation device in FIG. 1.

### DETAILED DESCRIPTION OF THE INVENTION

Hereinafter, a distance estimation device and a distance estimation method associated with the present disclosure will be described in detail with reference to the accompanying drawings. Even in different embodiments according to the present disclosure, the same or similar reference numerals are designated to the same or similar configurations, and the description thereof will be substituted by the earlier description. Unless clearly used otherwise, expressions in the singular number used in the present disclosure may include a plural meaning.

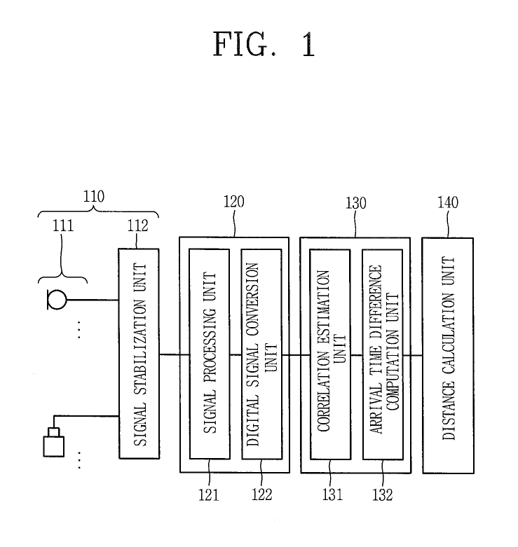

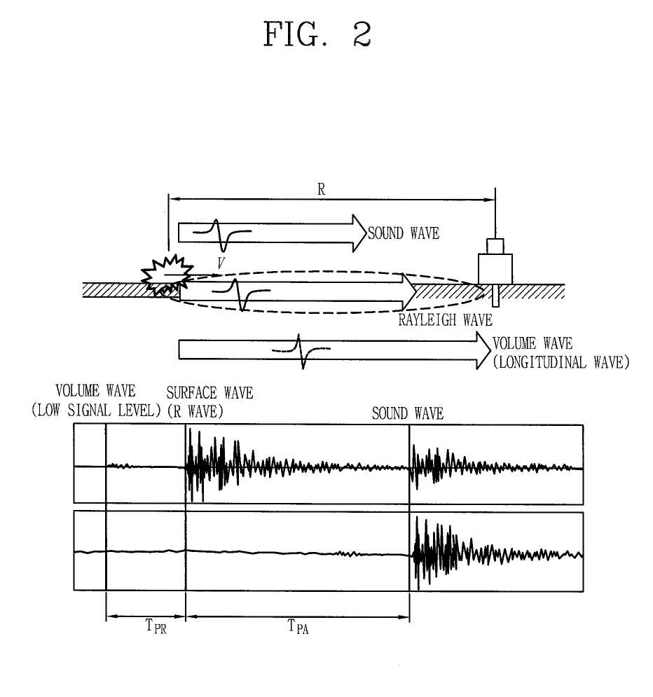

FIG. 1 is a configuration diagram illustrating the configuration of a distance estimation device according to an embodiment of the present disclosure, and FIG. 2 is a conceptual view illustrating the basic principle of a distance estimation device and a distance estimation method according to the present disclosure.

Referring to FIG. 1, a distance estimation device 100 may include a wave signal detection unit 110, a signal processing unit 120, a time delay estimation unit 130, and a distance calculation unit 140.

The wave signal detection unit wave 110 is configured to measure different types of waves, respectively, to detect different wave signals. For example, the wave signal detection unit 110 detects wave signals through a plurality of wave signal detectors 111 configured to measure wave signals, respectively.

The wave signal detection unit 110 may include a wave signal detector 111 and a signal stabilization unit 112.

A plurality of wave signal detectors 111 are provided to measure and detect the different types of waves, respectively. More specifically, the wave signal detector 111 detects wave signals for each type from a plurality of wave signal detectors. The wave signal detector 111 as a device for measuring and detecting different types of waves, respectively is connected to the signal stabilization unit 112 to amplify and stabilize the signal.

The signal stabilization unit 112 is provided with a plurality of signal conditioners connected to the wave signal detectors 111, respectively, to stabilize each of the wave signals. In other words, the signal stabilization unit 112 is connected to a plurality of signal conditioners, respectively, from a plurality of wave signal detectors, and used to stabilize each of the wave signals.

The signal processing unit 120 removes the noise of the detected wave signals and filters out signals in a specific frequency band transferring the same component signal. For example, the signal processing unit 120 removes noise from each of the wave signals and filters out signals in a specific frequency band transferring the signal, thereby generating stabilized and robust signals. The signal processing unit 120 may include an analog signal processing unit 121 and a digital signal conversion unit 122.

The analog signal processing unit 121 removes a noise signal and filters out signals in a specific frequency band for each of the wave signals transferred from the wave signal detection unit 110. The analog signal processing unit 121 generates more stabilized and robust signals through the removal and filtering.

The digital signal conversion unit 122 is formed to convert wave signals processed by the analog signal processing unit into a digital signal. For example, the digital signal conversion unit 122 converts the enhanced wave signals into a digital signal using an A/D conversion device. Digital filtering may be applicable again to digital converted data.

The time delay estimation unit 130 is configured to produce a correlation coefficient from the detected different wave signals, and compute an arrival time difference using the correlation coefficient.

More specifically, the time delay estimation unit 130 estimates an arrival time difference between each of the signals based on a correlation between the signals. The time delay estimation unit 130 may include a signal correlation estimation unit 131 configured to compute and produce a correlation between the signals, and an arrival time difference computation unit 132 configured to compute an arrival time difference for each of the different types of waves from the produced correlations.

The signal correlation estimation unit 131 computes a correlation between the signals from each of the digital converted measurement signal waveform. For example, the signal correlation estimation unit 131 computes correlations between signals through the computation of at least one of a time domain and a frequency domain using signal waveform data stored therein. The signal correlation estimation unit 131 computes correlations between signals through the computation of a time domain or a frequency domain using signal waveform data stored therein, respectively, according to the size of a given data block. They may include the computation of a linear or cyclic convolution, respectively.

In this case, the signal correlation estimation unit 131 may use interpolation and zero padding between data as a method of accurately estimating the location of a peak value from a correlation function between signals, and determine an estimation error for estimating an arrival time difference according to the sampling frequency.

The arrival time difference computation unit 132 computes an arrival time difference for each wave from correlations between the computed signals.

The arrival time difference computation unit 132 finds a peak value of correlation data between signals computed by the signal correlation estimation unit 131 to estimate an arrival time difference between signals based on the relevant time. A correlation function between signals in which a correlation between two signals is expressed as a function of time delay denotes that a correlation between two signals is higher as increasing the function value to be close to “1”. Therefore, a time delay having a peak with a high correlation denotes an arrival time difference between two signals. An arrival time difference may be accurately estimated using the function.

The method of computing a correlation between signals may include a method of employing a discrete convolution in a time domain and a method of employing an inverse conversion using a cross spectrum in a frequency domain. For a method of computing discrete data, both computation methods in a time domain or frequency domain may be used.

For a method of accurately estimating the location of a peak value from a correlation function between signals, interpolation or zero padding between data may be used. A time resolution for estimating an arrival time difference may be determined according to the sampling frequency to determine an estimation error.

The distance calculation unit 140 estimates the distance of a target object using an arrival time difference for each of the different types of waves. In other words, the distance calculation unit estimates a distance from the arrival time difference using a unique wave propagation speed for each wave used for distance estimation. More specifically, the distance calculation unit 140 estimates a distance from the arrival time difference of each wave signal using a medium propagation speed for each wave used for computation. Since each wave used for distance estimation has a unique wave propagation speed for each while being propagated through a medium, a distance is estimated from the arrival time difference using the unique wave propagation speed.

The distance calculation unit 140 should accurately find and use a wave propagation speed to produce an accurate distance. The wave propagation speed in a medium is affected by the composition ratio or ingredient of the medium as well as varied according to the surrounding environmental factors such as temperature, humidity, wind speed or the like. An accurate wave propagation speed is produced and used with the surrounding environmental factors as input parameters.

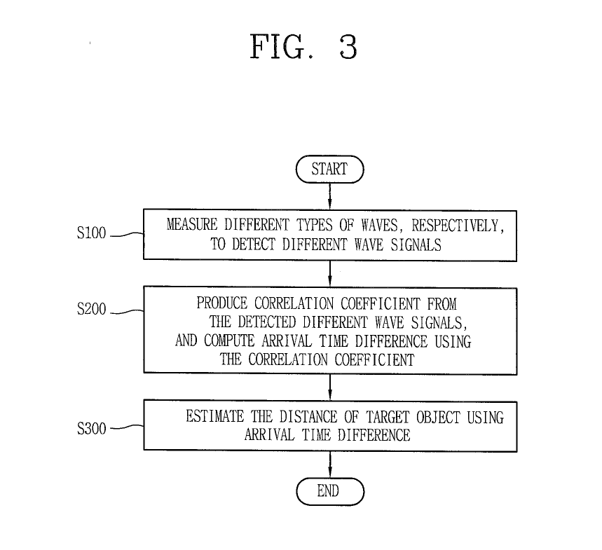

Hereinafter, a method of estimating a distance using the distance estimation device will be described in more detail. FIG. 3 is a flow chart illustrating a distance estimation method applicable to a distance estimation device in FIG. 1.

The distance estimation method may include measuring different types of waves, respectively, to detect different wave signals (S100), producing a correlation coefficient from the detected different wave signals, and computing an arrival time difference using the correlation coefficient (S200), and estimating the distance of a target object using an arrival time difference for each of the different types of waves (S300).

Referring to FIGS. 1 and 3, the distance estimation device 100 detects each wave signal from detectors measuring a plurality of different waves, respectively, to compute a distance therefrom. The distance estimation device 100 detects wave signals for each type through a plurality of wave signal detectors measuring each of the wave signals.

Furthermore, the distance estimation device 100 is connected to a plurality of signal conditioners, respectively, from a plurality of wave signal detectors to stabilize each of the wave signals. The distance estimation device 100 removes noise signals contained in the signal for each of the received signals and filters out signals in a specific frequency band to generate stabilized and robust signals.

The distance estimation device 100 converts the enhanced wave signals into a digital signal using an A/D conversion device. Furthermore, digital filtering may be applicable to obtain signals in a desired frequency band. The distance estimation device 100 computes a correlation between signals from each of the digital converted measurement signal waveform. The signal correlation estimation unit 131 computes correlations between signals using signal waveform data stored therein, respectively, according to the size of a given data block. The correlations between signals are computed by the computation of a linear or cyclic convolution in a time domain or frequency domain. The method of computing a correlation between signals may include a method of employing a discrete convolution in a time domain and a method of employing an inverse conversion using a cross spectrum in a frequency domain. For a method of computing discrete data, both computation methods in a time domain or frequency domain may be used.

The distance estimation device 100 finds a peak value of the computed correlation function between signals to estimate an arrival time difference between signals based on the relevant time. The correlation function between signals is computed as a function of time delay, and because of denoting that a correlation between two signals is higher as increasing the value, a time having the highest correlation denotes an arrival time difference between two signals, and the arrival time difference between two signals is accurately estimated from the time. For a method of estimating the highest value of a correlation function, interpolation or zero padding may be used. A time resolution for estimating an arrival time difference may be determined according to the sampling frequency to determine an estimation error.

The distance estimation device 100 estimates a distance from the arrival time difference of each wave signal. Since each wave used for distance estimation has a unique wave propagation speed for each while being propagated through a medium, a distance is estimated from the arrival time difference using the unique wave propagation speed. The wave propagation speed should be accurately found and used to produce an accurate distance, but the wave propagation speed in a medium is affected by the composition ratio or ingredient of the medium as well as varied according to the surrounding environmental factors such as temperature, humidity, wind speed or the like. Accordingly, an accurate wave propagation speed is produced using the surrounding environmental factors as input parameters.

The configurations and methods according to the above-described embodiments will not be applicable in a limited way to the foregoing distance estimation device and distance estimation method, and all or part of each embodiment may be selectively combined and configured to make various modifications thereto.

What is claimed is:

1. A distance estimation device, comprising:
a wave signal detection unit configured to measure different types of waves, respectively, to detect different wave signals;
a time delay estimation unit configured to produce a correlation coefficient from the detected different wave signals, and computes an arrival time difference using the correlation coefficient; and
a distance calculation unit configured to estimate the distance of a target object using an arrival time difference for each of the different types of waves.

2. The distance estimation device of claim 1, wherein the wave signal detection unit comprises:
a plurality of wave signal detectors formed to measure and detect the different types of waves, respectively; and
a signal stabilization unit having a plurality of signal conditioners connected to the wave signal detectors, respectively, to stabilize each of the wave signals.

3. The distance estimation device of claim 1, further comprising:
a signal processing unit configured to remove the noise of the detected wave signals and filter out signals in a specific frequency band transferring the same component signal.

4. The distance estimation device of claim 3, wherein the signal processing unit comprises:
an analog signal processing unit configured to remove a noise signal and filter out signals in a specific frequency band for each of the wave signals transferred from the wave signal detection unit; and
a digital signal conversion unit configured to convert wave signals processed by the analog signal processing unit into a digital signal.

5. The distance estimation device of claim 1, wherein the time delay estimation unit comprises:
a signal correlation estimation unit configured to compute and produce a correlation between the detected different wave signals; and
an arrival time difference computation unit configured to compute an arrival time difference for each of the different types of waves from the produced correlations.

6. The distance estimation device of claim 5, wherein the signal correlation estimation unit computes correlations between signals through the computation of at least one of a time domain and a frequency domain using signal waveform data stored therein.

7. The distance estimation device of claim 6, wherein the signal correlation estimation unit uses interpolation and zero padding between data as a method of accurately estimating the location of a peak value from a correlation function between signals, and determines an estimation error for estimating an arrival time difference according to the sampling frequency.

8. The distance estimation device of claim 1, wherein the distance calculation unit estimates a distance from an arrival time difference using a unique wave propagation speed for each wave used for distance estimation.

9. A distance estimation method, the method comprising:
measuring different types of waves, respectively, to detect different wave signals;
producing a correlation coefficient from the detected different wave signals, and computing an arrival time difference using the correlation coefficient; and
estimating the distance of a target object using an arrival time difference for each of the different types of waves.
